(19) United States
(12) Patent Application Publication
(10) Pub. No.: US 2021/0215969 A1
(43) Pub. Date: Jul. 15, 2021

(54) Display Panel, Manufacturing Method Thereof and Display Device

(71) Applicants: BOE Technology Group Co., Ltd., Beijing (CN); Hefei BOE Optoelectronics Technology Co., Ltd., Hefei (CN)

(72) Inventors: Li Sun, Beijing (CN); Fengjing Tang, Beijing (CN); Jian Tao, Beijing (CN); Hongmin Li, Beijing (CN)

(73) Assignees: BOE Technology Group Co., Ltd., Beijing (CN); Hefei BOE Optoelectronics Technology Co., Ltd., Hefei (CN)

(21) Appl. No.: 16/093,081

(22) PCT Filed: Feb. 13, 2018
(86) PCT No.: PCT/CN2018/076606

§ 371 Date: Oct. 11, 2018

(30) Foreign Application Priority Data
Jun. 29, 2017 (CN) 201710513056.0

(51) Int. Cl. G02F 1/1335; G02F 1/1337

(52) U.S. Cl. CPC G02F 1/133531; G02F 1/1337

(57) ABSTRACT

A display panel, a manufacturing method thereof, and a display device are provided. The display panel includes a first substrate and a reflective second substrate opposite to each other; a liquid crystal (LC) layer located between the first substrate and the second substrate; a first polarizer layer located at a side of the LC layer far away from the second substrate; a second polarizer layer located between the LC layer and the second substrate, the second polarizer layer being configured to allow transmitted light to have a first polarization direction. In the case where the LC layer is not applied with any voltage, light transmitted through the LC layer and the first polarizer layer has a second polarization direction, and the first polarization is substantially perpendicular to the second polarization direction.

The application claims priority of Chinese patent application No. 201710513056.0 filed on Jun. 29, 2017, the entire disclosure of which is incorporated herein by reference as part of the present application.

### TECHNICAL FIELD

At least one embodiment of the present disclosure relates to a display panel, a manufacturing method thereof, and a display device.

### BACKGROUND

Reflective display product can achieve display function by utilizing ambient light, possesses advantages of low power consumption as well as smaller weight and reduced thickness, and hence has been increasingly favored by customers. However, an existing reflective display product is insufficient in a contrast ratio when displaying an image, which results in a poor display effect.

### SUMMARY

At least one embodiment of the present disclosure provides a display panel, including a first substrate; a reflective second substrate, disposed in opposite to the first substrate; a liquid crystal (LC) layer located between the first substrate and the second substrate; a first polarizer layer located at a side of the LC layer far away from the second substrate; a second polarizer layer located between the LC layer and the second substrate, the second polarizer layer being configured to allow transmitted light to have a first polarization direction. In the case where the LC layer is not applied with any voltage, light transmitted through the LC layer and the first polarizer layer has a second polarization direction, and the first polarization is substantially perpendicular to the second polarization direction.

For example, the display panel provided by at least one embodiment of the present disclosure further includes an alignment layer, the alignment layer is located on at least one of the first substrate and the second substrate, the alignment layer is configured to allow the LC layer to have a same, initial twist angle in the case where the LC layer is not applied with any voltage.

For example, in the display panel provided by at least one embodiment of the present disclosure, the first polarizer layer is configured to allow transmitted light to have a third polarization direction, and the initial twist angle of the LC layer is set as 0 degree, the third polarization direction is perpendicular to the first polarization direction.

For example, in the display panel provided by at least one embodiment of the present disclosure, the first polarizer layer is configured to allow transmitted light to have a third polarization direction, and the initial twist angle of the LC layer is set as 90 degrees, the third polarization direction is parallel to the first polarization direction.

For example, in the display panel provided by at least one embodiment of the present disclosure, the second polarizer layer is configured as a nano grating.

For example, in the display panel provided by at least one embodiment of the present disclosure, the first polarizer layer is disposed between the first substrate and the second substrate; or the first polarizer layer is disposed at a side of the first substrate far away from the second substrate.

For example, the display panel provided by at least one embodiment of the present disclosure includes a plurality of pixel units, and each of the pixel units includes at least one sub-pixel unit, and an interval region between adjacent sub-pixel units is in a normally black state.

For example, in the display panel provided by at least one embodiment of the present disclosure, the second substrate includes a plurality of gate lines and data lines, the gate lines and the data lines are intersected with each other to define the at least one sub-pixel unit, a position on the second substrate corresponding to each sub-pixel unit is provided with a pixel electrode.

For example, in the display panel provided by at least one embodiment of the present disclosure, the pixel electrode is configured as a reflective electrode, and the pixel electrode is located between the second polarizer layer and the second substrate.

For example, in the display panel provided by at least one embodiment of the present disclosure, a side of the first substrate facing the LC layer is provided with a common electrode, the pixel electrode and the common electrode are configured to apply a voltage onto the LC layer so as to adjust a twist degree of the LC layer corresponding to the sub-pixel unit.

At least one embodiment of the present disclosure provides a display device including the display panel in any of the embodiments above.

At least one embodiment of the present disclosure provides a manufacturing method of a display panel, including: providing a first substrate, and forming a first polarizer layer on the first substrate; providing a reflective second substrate, and forming a second polarizer layer on the second substrate, the second polarizer layer allowing transmitted light to have a first polarization direction; assembling the first substrate with the second substrate to form a cell, and forming a liquid crystal (LC) layer between the first substrate and the second substrate. The first polarizer layer is formed at a side of the LC layer far away from the second substrate, the second polarizer layer is formed between the second substrate and the LC layer, and in the case where the LC layer is not applied with any voltage, light transmitted through the LC layer and the first polarizer layer has a second polarization direction, the first polarization is substantially perpendicular to the second polarization direction.

For example, the manufacturing method provided by at least one embodiment of the present disclosure can further include: forming an alignment layer on at least one of the first substrate and the second substrate. The alignment layer allows the LC layer to have a same, initial twist angle in the case where the LC layer is not applied with any voltage.

For example, in the manufacturing method provided by at least one embodiment of the present disclosure, the first polarizer layer allows transmitted light to have a third polarization direction, and the initial twist angle of the LC layer is set as 0 degree, the third polarization direction is perpendicular to the first polarization direction; or, the first polarizer layer allows transmitted light to have a third polarization direction, and the initial twist angle of the LC layer is set as 90 degrees, the third polarization direction is parallel to the first polarization direction.

For example, the manufacturing method provided by at least one embodiment of the present disclosure can further include: forming a common electrode at a side of the first substrate facing the LC layer, and forming a pixel electrode at a side of the second substrate facing the LC layer. The pixel electrode and the common electrode apply the LC layer with a voltage so as to adjust a twist degree of the LC layer corresponding to the sub-pixel unit.

### BRIEF DESCRIPTION OF THE DRAWINGS

In order to clearly illustrate the technical solution of the embodiments of the disclosure, the drawings of the embodiments will be briefly described in the following. It is obvious that the described drawings are only related to some embodiments of the disclosure but not limitative of the present disclosure.

FIG. 1 is a sectional view illustrating a display panel provided by an embodiment of the present disclosure;

FIG. 2 is a partially sectional view illustrating a display panel provided by an embodiment of the present disclosure;

FIG. 3 is a partially sectional view illustrating another display panel provided by an embodiment of the present disclosure;

FIG. 4 is a top view illustrating a display panel provided by an embodiment of the present disclosure;

FIG. 5 is a partially structural diagram illustrating one sub-pixel unit in the display panel as illustrated in FIG. 4;

FIG. 6 is a sectional view of the display panel as illustrated in FIG. 4 along line M-N; and

FIGS. 7a-7c, FIGS. 8a-8c and FIG. 9 are process diagrams of a manufacturing method of a display panel provided by an embodiment of the present disclosure.

Reference Numerals:

100—first substrate; 200—second substrate; 300—LC layer; 400—first polarizer layer; 500—second polarizer layer; 600—alignment layer; 610—first alignment layer; 620—second alignment layer; 700—pixel unit; 710—sub-pixel unit; 720—interval region; 810—gate line; 820—data line; 910—pixel electrode; 920—common electrode.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

At least one embodiment of the present disclosure provides a display panel, a manufacturing method thereof and a display device. The display panel includes a first substrate, a reflective second substrate, a liquid crystal (LC) layer, a first polarizer layer and a second second polarizer. The first substrate and the second substrate are opposite to each other; the LC layer is located between the first substrate and the second substrate; the first polarizer layer is located at a side of the LC layer far away from the second substrate; the second polarizer layer is located between the LC layer and the second substrate, the second polarizer layer is configured to allow transmitted light to have a first polarization direction. In the case where the LC layer is not applied with any voltage, light transmitted through the LC layer and the first polarizer layer has a second polarization direction, and the first polarization is substantially perpendicular to the second polarization direction. In the case where the LC layer is not applied with any voltage, ambient incident light that has been transmitted through the first polarizer layer and the LC layer cannot be transmitted through the second polarizer layer. As a result, the display panel can achieve a normally black state, so as to improve the contrast ratio of the display panel when displaying an image and to improve the display effect.

For example, in at least one embodiment of the present disclosure, the type of the first substrate and the type of the second substrate are not particularly limited. For example, the second substrate can be an array substrate, and the first substrate can be an opposed substrate such as a color filter (CF) substrate.

It should be explained that, in at least one embodiment of the present disclosure, the LC layer being applied with no voltage is not limited to the case where the display panel is in a working condition. For example, when the display panel is in a non-display state, the entire LC layer is not applied with any voltage so that the entire display panel is in a black state; for example, when the display panel is in a display state, a portion of the LC layer is applied with a voltage and is corresponding to a first region of the display panel, while the other portion of the LC layer is not applied with any voltage and is corresponding to a second region of the display panel. In this way, a portion of the display panel corresponding to the second region is in a black state.

Hereinafter, the display panel, the manufacturing method thereof and the display device of at least one embodiment of the present disclosure will be described in more details in connection with the drawings.

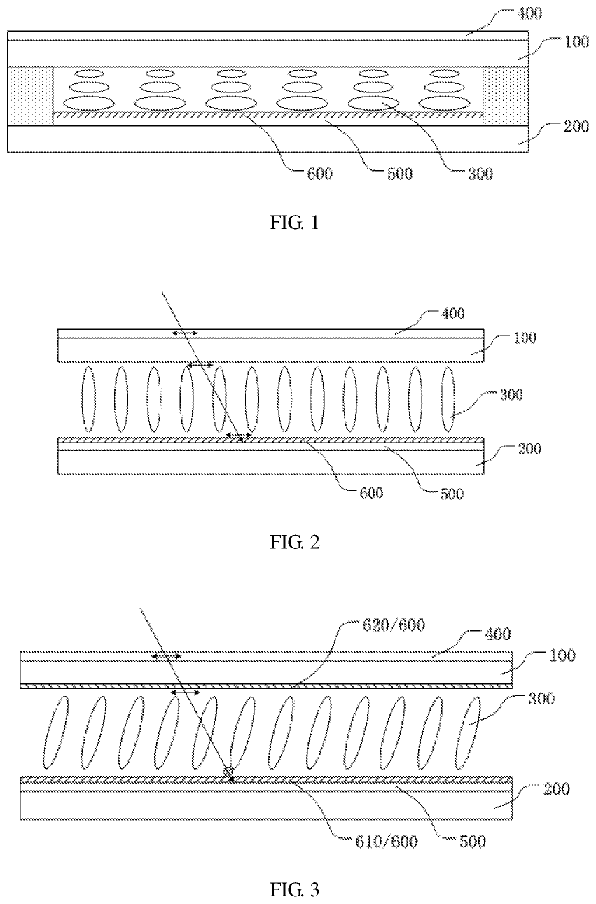

At least one embodiment of the present disclosure provides a display panel. FIG. 1 is a sectional view illustrating a display panel provided by an embodiment of the present disclosure. For example, as illustrated in FIG. 1, the display panel can include a first substrate 100 and a reflective second substrate 200 opposite to each other; a liquid crystal (LC) layer 300; a first polarizer layer 400; and a second second polarizer 500. The LC layer 300 is disposed between the first substrate 100 and the second substrate 200; the first polarizer layer 400 is disposed at a side of the LC layer 300 far away from the second substrate 200; the second polarizer layer 500 is configured to allow transmitted light to have a first polarization direction, and is disposed between the LC layer 300 and the second substrate 200. The LC layer 300 applied with no voltage and the first polarizer layer 400 are configured to allow transmitted light to have a second polarization direction, and the first polarization is substantially perpendicular to the second polarization direction. For example, when the display panel is in a non-display state (the LC layer 300 maintains in an initial state and is not applied with any voltage), the ambient incident light transmitted through the first polarizer layer 400 and the LC layer 300 is changed into polarization light having a second polarization direction. Because the second polarizer layer 500 enables the transmitted light to have a first polarization direction substantially perpendicular to the second polarization direction, the light transmitted through the first polarizer layer 400 and the LC layer 300 cannot be transmitted through the second polarizer layer 500. In this way, the ambient light that is incident into the display panel will not be reflected and exit through the second substrate 200; that is to say, the display panel can achieve a normally black state. When the display panel is in a display state, it can improve the contrast ratio of the image as displayed and improve the display effect of the display panel. Additionally, at a display side of the display panel, all the incident light that is transmitted through the first polarizer layer 400 can enter the display panel. As compared with the existing structure of display panel, the ambient light will not be blocked by structures such as black matrix; that is, the amount of incoming light is increased. As a result, when the display panel is in a display state, it can improve the brightness of the image as displayed.

For example, in at least one embodiment of the present disclosure, the first substrate 100 can be a color filter (CF) substrate and includes a plurality of CF units each corresponding to a sub-pixel (referring to the sub-pixel unit 710 in the embodiments below) of the display panel.

It should be explained that, in at least one embodiment of the present disclosure, the first polarization direction is substantially perpendicular to the second polarization direction; that is, the first polarization direction can be perpendicular to the second polarization direction, or an included angle between the first polarization direction and the second polarization direction is permitted to vary within a certain angle range. For example, the included angle between the first polarization direction and the second polarization direction can be in the range from about 80 degrees to 90 degrees, further, about 85 degrees to 90 degrees. Arrangements among the LC layer 300, the first polarizer layer 400 and the second polarizer layer 500 allow a transmittance of the light transmitted through the three layers to be reduced to a tolerable range as long as the LC layer 300 in the display panel is not applied with any voltage; that is, allowing the display panel to be in a normally black state or close to the normally black state; in such condition, the included angle between the first polarization direction and the second polarization direction is not particularly limited. Hereinafter, the technical solution in at least one embodiment of the present disclosure will be described with reference to the case where the first polarization direction is perpendicular to the second polarization direction by way of example.

In at least one embodiment of the present disclosure, the specific position of the first polarizer layer 400 is not particularly limited. For example, as illustrated in FIG. 1, the first polarizer layer 400 can be disposed between the first substrate 100 and the second substrate 200, and can also be disposed at a side of the first substrate 100 far away from the second substrate 200.

For example, in at least one embodiment of the present disclosure, the LC layer 300 can be pre-aligned. The LC layer 300 can be cooperated with the first polarizer layer 400 so that the light transmitted through the two layers has a certain polarization direction (for example, when the LC layer 300 is not applied with any voltage, the light transmitted through the two layers has a second polarization direction). For example, as illustrated in FIG. 1, in at least one embodiment of the present disclosure, the second substrate 200 is provided with an alignment layer 600; the alignment layer 600 can be located between the second substrate 200 and the LC layer 300; the alignment layer 600 is configured to allow the LC layer 300 applied with no voltage to have a same, initial twist angle. In this way, when the LC layer 300 is not applied with any voltage, the incident light that is transmitted through the first polarizer layer 400 and the LC layer 300 can have a same polarization direction, for example, a second polarization direction, so as to ensure that the incident light cannot be transmitted through the second polarizer layer 500, which allows the display panel to achieve a normally black state.

It should be explained that, in at least one embodiment of the present disclosure, the alignment layer 600 is not limited to be disposed only on the second substrate 200 but can also be disposed on the first substrate 100, as long as at least one of the first substrate 100 and the second substrate 200 is provided with the alignment layer 600. The specific arrangement of the alignment layer 600 can be referred to related contents in the embodiments below, without repeating details herein.

In at least one embodiment of the present disclosure, when the LC layer 300 is not applied with no voltage, by means of a cooperation between the first polarizer layer 400 and the LC layer 300, the light can have a second polarization direction before it's incident onto the second polarizer layer 500. As a result, in at least one embodiment of the present disclosure, the specific arrangement of the first polarizer layer 400 and the LC layer 300 is not particularly limited, as long as the first polarizer layer 400 and the LC layer 300 can allow the light transmitted through the two layers to have a certain polarization direction, for example, a second polarization direction. Hereinafter, in at least one embodiment of the present disclosure, the specific arrangement relationship between the first polarizer layer 400 and the LC layer 300 will be described with reference to the case where the first polarizer layer 400 is configured to allow transmitted light to have a third polarization direction, by way of example.

For example, in at least one embodiment of the present disclosure, FIG. 2 is a partially sectional view of a display panel provided by an embodiment of the present disclosure and illustrates an area in which the LC layer is not applied with any voltage. For example, as illustrated in FIG. 2, the initial twist angle of the LC layer 300 can be set as about 0 degree, then the first polarizer layer 400 and the second polarizer layer 500 are configured to allow the light transmitted through the two layers respectively to have polarization directions perpendicular to each other; that is, the third polarization direction is perpendicular to the first polarization direction. When the LC layer 300 is not applied with any voltage, it will not affect the polarization direction of the transmitted light. In this way, the incident light transmitted through the first polarization layer 400 and the LC layer 300 has a second polarization direction which is parallel to the third polarization direction, and the incident light cannot be transmitted through the second polarizer layer 500, so that the display panel can achieve a normally black state.

As illustrated in FIG. 2, the initial twist angle of the LC layer 300 is set as 0 degree, and an alignment layer 600 can be disposed at one side of the LC layer 300; for example, the alignment layer 600 is disposed at a side of the second substrate 200 facing the LC layer 300.

For example, in at least one embodiment of the present disclosure, FIG. 3 is a partially sectional view of another display panel provided by an embodiment of the present disclosure and illustrates an area in which the LC layer is not applied with any voltage. For example, as illustrated in FIG. 3, the initial twist angle of the LC layer 300 can be set as about 90 degrees, then the first polarizer layer 400 and the second polarizer layer 500 are configured to allow the light transmitted through the first polarizer layer 400 to have a polarization direction parallel to that of the light transmitted through the second polarizer layer 500; that is, the third polarization direction is parallel to the first polarization direction. When the LC layer 300 is not applied with any voltage, it can rotate the polarization direction of the transmitted light by 90 degrees. In this way, the incident light transmitted through the first polarization layer 400 and the LC layer 300 has a second polarization direction which is perpendicular to the third polarization direction. As a result, the incident light cannot be transmitted through the second polarizer layer 500, so that the display panel can achieve a normally black state.

As illustrated in FIG. 3, the initial twist angle of the LC layer 300 is set as 90 degrees, and an alignment layer 600 can be disposed at both sides of the LC layer 300; for example, a first alignment layer 610 is disposed at a side of the second substrate 200 facing the LC layer 300, a second alignment layer 620 is disposed at a side of the first substrate 100 facing the LC layer 300, and a rubbing direction of the first alignment layer 610 is perpendicular to a rubbing direction of the second alignment layer 620. In this way, the LC layer 300 can have an initial twist angle of 90 degrees.

It should be explained that, in at least one embodiment of the present disclosure, the specific arrangement relationship between the first polarizer layer 400 and the second polarizer layer 500 (a relationship between the third polarization direction and the first polarization direction) can be defined by the initial twist angle of the LC layer 300, while the initial twist angle of the LC layer 300 is determined according to actual demands. The initial twist angle of the LC layer 300 is not particularly limited in the embodiments of the present disclosure, so the third polarization direction and the first polarization direction are not limited to be parallel to each other or be perpendicular to each other as described above.

For example, the initial twist angle of the LC layer 300 can also be set as 20 degrees, and then the included angle between the third polarization direction and the first polarization direction can be set as 110 degrees or 70 degrees, which can also enable the display panel to achieve a normally black state. Hereinafter, the technical solution of at least one embodiment of the present disclosure will be described with reference to the case of FIG. 3 in which the initial twist angle of the LC layer 300 is 90 degrees and the third polarization direction is parallel to the first polarization direction, by way of example.

For example, in at least one embodiment of the present disclosure, as illustrated in FIG. 3, the second polarizer layer 500 can be configured as a nano grating or the like. In at least one embodiment of the present disclosure, the specific structural parameter of the nano grating 500 is not particularly limited, as long as it allows the transmitted light to have a certain polarization direction. For example, the nano grating 500 can include a plurality of grating strips arranged in parallel, and each of the grating strips has a width which may be 50-80 nm; a ratio of the width of the grating strip and a spaced distance between adjacent grating strips is ⅔-1; in a direction perpendicular to a plane of the nano grating 500, a thickness of the grating strip is in the range from 150 to 250 nm. The nano grating 500 can be made of a metallic material or a polymer (e.g., polydimethylsiloxane) and the like. The embodiments of the present disclosure include but are not limited thereto. For example, the nano grating 500 can be manufactured on the second substrate 200 by nanoimprint lithography and the like.

It should be explained that, in at least one embodiment of the present disclosure, the specific structure of the first polarizer layer 400 and the second polarizer layer 500 is not particularly limited. For example, the polarizer layer 500 is not limited to the nano grating structure described above, as long as it allows the transmitted light to have a certain polarization direction (e.g., the first polarization direction). For example, the second polarizer layer 500 can also be configured as a polaroid or the like. For example, the first polarizer layer 400 can also be configured as a polaroid, a nano grating or other structures with polarization function.

FIG. 4 is a top view illustrating a display panel provided by an embodiment of the present disclosure. For example, as illustrated in FIG. 4, in at least one embodiment of the present disclosure, the display panel includes a plurality of pixel units 700, each of the pixel units 700 includes at least one sub-pixel unit 710, and an interval region 720 is existed between adjacent sub-pixel unis 710. When the display panel is in a non-display state, both of the sub-pixel unit 710 and the interval region 720 are in a black state; when the display panel is in a display state, the interval region 720 is in a black state; that is, the interval region 720 between adjacent sub-pixel units 710 is in a normally black state. In this way, it no longer needs to arrange a black matrix corresponding to the interval region 720, which can simplify the manufacturing process of the display panel and reduce the cost.

For example, in at least one embodiment of the present disclosure, the type and amount of the sub-pixel units 710 included in the pixel unit 700 are not particularly limited. For example, each of the pixel units 700 can include sub-pixel units 710 of three colors, i.e., red, green and blue.

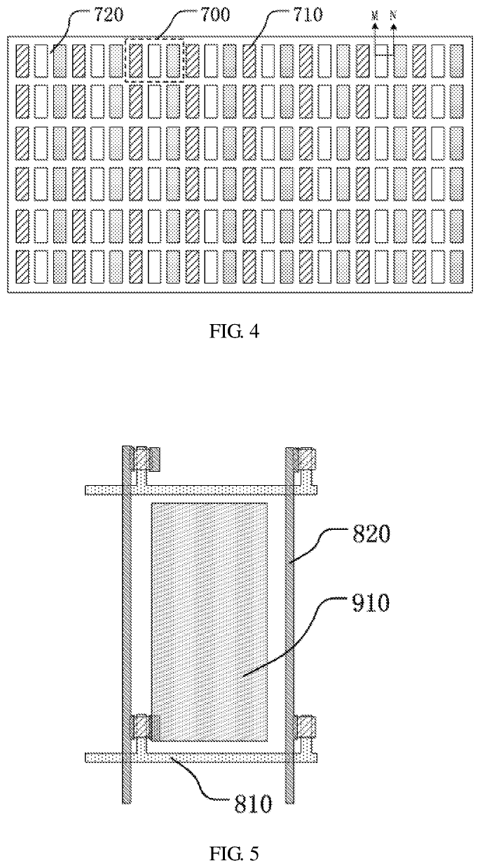

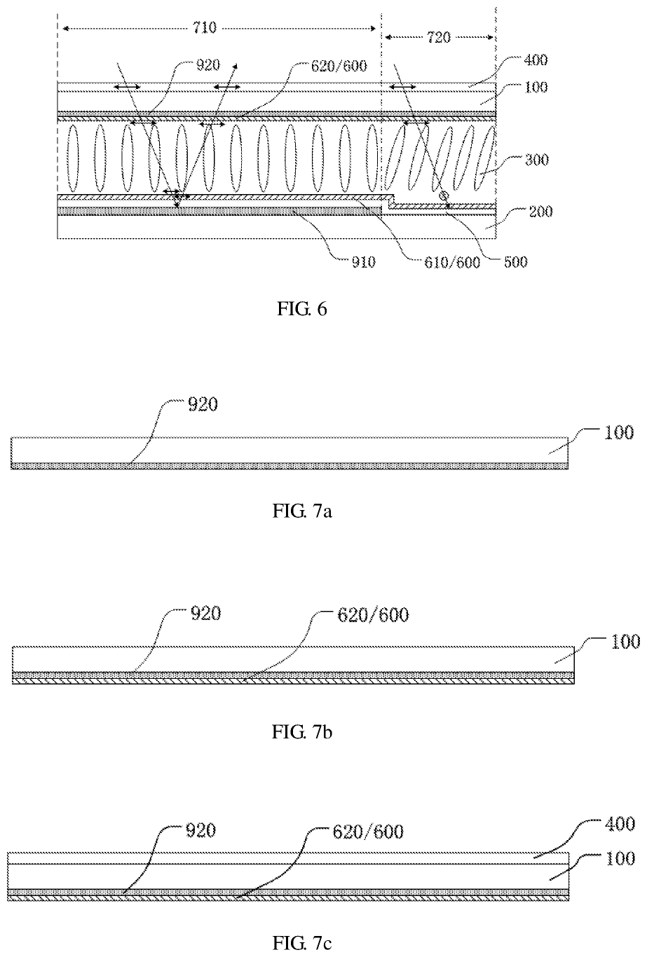

FIG. 5 is a partially structural diagram illustrating one sub-pixel unit in the display panel as illustrated in FIG. 4. For example, as illustrated in FIG. 5, in at least one embodiment of the present disclosure, the second substrate 200 can include a plurality of gate lines 810 and a plurality of data lines 820; the gate lines 810 and the data lines 820 are intersected with each other to define at least one sub-pixel unit 710; a position on the second substrate 200 corresponding to each of the sub-pixel units 710 is provided with a pixel electrode 910. The region where the pixel electrode 910 is located is not limited to that illustrated in FIG. 5. The pixel electrode 910 can be disposed to partly cover the gate line 810 or the data line 820. The specific position of the pixel electrode 910 can be determined according to actual demands, without repeating the details in the present disclosure. The pixel electrode 910 can apply a voltage onto the LC layer 300 in the sub-pixel unit 710 to change a twist degree of the LC layer 300. The specific operation can be referred to related contents in the embodiments below (the embodiment as illustrated in FIG. 6) without repeating the details herein.

For example, in at least one embodiment of the present disclosure, the pixel electrode 910 can be configured as a transparent electrode. In this way, a reflective layer can be disposed at least on the second substrate in the sub-pixel unit 710 so as to reflect the incident light in the sub-pixel unit 710. For example, the pixel electrode 910 can be made of a transparent conductive material, a metallic material or the like. For example, the pixel electrode 910 can be made of a material including indium tin oxides (ITO), indium zinc oxide (IZO), indium gallium oxide (IGO), gallium oxide zinc (GZO), zinc oxide (ZnO), indium oxide (In₂O₃), Alumina zinc (AZO), nanotube and the like.

For example, in at least one embodiment of the present disclosure, the pixel electrode 910 can be configured as a reflective electrode. For example, the pixel electrode 910 is located between the second polarizer layer and the second substrate 200. In this way, it has no need of additionally arranging a reflective layer (a structure for reflecting the incident light) or the like in the second substrate 200. For example, the pixel electrode 910 can include a metallic conductive material such as Al, copper and an alloy thereof. Hereinafter, the technical solution in at least one embodiment below of the present disclosure will be described with reference to the case where the pixel electrode 910 is configured as a reflective electrode, by way of example.

FIG. 6 is a sectional view of the display panel as illustrated in FIG. 4 along line M-N. For example, as illustrated in FIG. 6, in at least one embodiment of the present disclosure, a side of the first substrate 100 of the display panel facing the LC layer 300 can be provided with a common electrode 920; the pixel electrode 910 and the common electrode 920 are configured to apply a voltage onto the LC layer 300 to adjust a twist degree of the LC layer 300 corresponding to the sub-pixel unit 710. In this way, it can control on and off of the display state of the sub-pixel unit 710, and can control a gray level of an image displayed by the sub-pixel unit 710. It should be explained that, the specific position of the common electrode 920 is not limited in the present disclosure, as long as an electric field in a direction perpendicular to the plane of the second substrate 200 is generated between the common electrode 920 and the pixel electrode 910. The common electrode 920 can be configured as a strip electrode and is disposed to be corresponding to the pixel electrode 910 in the sub-pixel unit 710; additionally, the common electrode 920 can also be configured as a planar electrode.

In at least one embodiment of the present disclosure, as illustrated in FIG. 6, the display panel is in a display state and the sub-pixel unit 710 illustrated in FIG. 6 is in a state of image display.

For example, as illustrated in FIG. 6, in a region corresponding to the sub-pixel unit 701 on the display panel, after the LC layer 300 is applied with a voltage by the pixel electrode 910 and the common electrode 920, a twist angle of the LC layer 300 in the sub-pixel unit 710 is changed to 0 degree. In such case, the LC layer 300 in the sub-pixel unit 710 would not affect the polarization direction of the light transmitted through the first polarizer layer 400; that is, the ambient incident light transmitted through the first polarizer layer 400 and the LC layer 300 has a second polarization direction which is parallel to the third polarization direction, and the third polarization direction is parallel to the first polarization direction of the second polarizer layer; as a result, the incident light will be transmitted through the second polarizer layer 500. The incident light that is reflected by the pixel electrode 910 will be transmitted through the second polarizer layer 500, the LC layer 300 and the first polarizer layer 400, sequentially, and then exits. In this way, the sub-pixel unit 710 can display an image. Additionally, by controlling a twist degree of the LC layer 300 in the sub-pixel unit 710, the transmittance of the incident light passing through the second polarizer layer 500 can be controlled, so as to control the gray level of the sub-pixel unit 710 when displaying an image.

For example, in an interval region 720 of the display panel, the LC layer 300 would not be affected by the voltage applied by the pixel electrode 910 and the common electrode 920, so that the twist angle of the LC layer 300 in the interval region 720 is still the initial twist angle (e.g., rotating the polarization direction of the transmitted light by 90 degrees). As a result, the incident light that is transmitted through the first polarizer layer 400 and the LC layer 500 will not be transmitted through the second polarizer layer 500; that is, the interval region 720 of the display panel is in a black state.

At least one embodiment of the present disclosure provides a display device. The display device can include the display panel described in any of the embodiments above. For example, the display device can be any LCD product or component having display function, such as mobile phone, tablet computer, television, displayer, notebook computer and navigator.

At least one embodiment of the present disclosure provides a manufacturing method of a display panel, including: providing a first substrate, and forming a first polarizer layer on the first substrate; providing a reflective second substrate, and forming a second polarizer layer on the second substrate, the second polarizer layer allowing transmitted light to have a first polarization direction; assembling the first substrate with the second substrate to form a cell, and forming a liquid crystal (LC) layer between the first substrate and the second substrate. The first polarizer layer is located at a side of the LC layer far away from the second substrate, the second polarizer layer is located between the second substrate and the LC layer, and in the case where the LC layer is not applied with any voltage, light transmitted through the LC layer and the first polarizer layer has a second polarization direction, the first polarization is substantially perpendicular to the second polarization direction. When the LC layer is not applied with any voltage, ambient incident light that has been transmitted through the first polarizer layer and the LC layer cannot be transmitted through the second polarizer layer, thus the display panel can achieve a normally black state, thereby improving the contrast ratio of image display of the display panel and the display effect. The specific structure of the display panel can be referred to the foregoing embodiments (the embodiments related to the display panel) without repeating the details herein.

For example, the manufacturing method provided by at least one embodiment of the present disclosure can further include: forming an alignment layer on at least one of the first substrate and the second substrate. The alignment layer allows the LC layer applied with no voltage to have a same, initial twist angle. The alignment layer allows the incident light transmitted through the first polarizer layer and the LC layer to have a same polarization direction, e.g., the second polarization direction.

For example, in the manufacturing method provided by at least one embodiment of the present disclosure, the first polarizer layer allows transmitted light to have a third polarization direction, and the initial twist angle of the LC layer is set as 0 degree, the third polarization direction is perpendicular to the first polarization direction; or, the first polarizer layer allows transmitted light to have a third polarization direction, and the initial twist angle of the LC layer is set as 90 degrees, the third polarization direction is parallel to the first polarization direction. The initial twist angle of the LC layer is not limited to the above two values, and the specific configuration thereof can be referred to related contents in the embodiments above (the embodiments related to the display panel) without repeating the details herein.

For example, the manufacturing method provided by at least one embodiment of the present disclosure can further include: forming a common electrode at a side of the first substrate facing the LC layer, and forming a pixel electrode at a side of the second substrate facing the LC layer. The pixel electrode and the common electrode apply a voltage onto the LC layer so as to adjust a twist degree of the LC layer corresponding to the sub-pixel unit. By controlling the electric field between the pixel electrode and the common electrode, the twist degree of the LC layer in the sub-pixel unit can be controlled, so as to control the on-off state of the sub-pixel unit when displaying an image and to control the gray level of the image as displayed.

Hereinafter, in at least one embodiment of the present disclosure, the manufacturing method of the display panel is described with reference to the structure of the display panel as illustrated in FIG. 6, by way of example. FIGS. 7a-7c, FIGS. 8a-8c and FIG. 9 are process diagrams of a manufacturing method of a display panel provided by an embodiment of the present disclosure. For example, as illustrated in FIGS. 7a-7c, FIGS. 8a-8c and FIG. 9, the manufacturing method of the display panel provided by at least one embodiment of the present disclosure can include processes as below.

As illustrated in FIG. 7a, providing a first substrate 100 and forming a common electrode 920 at a side of the first substrate 100.

As illustrated in FIG. 7b, forming a second alignment layer 620 at the side of the first substrate 100 where the common electrode 920 is disposed.

As illustrated in FIG. 7c, forming a first polarizer layer 400 on a first substrate 100, the first polarizer layer 400 allows transmitted light to have a third polarization direction. The first polarizer layer 400 can be formed at a side of the first substrate 100 far away from the common electrode 920, and can also be formed at a side of the first substrate 100 where the common electrode 920 is disposed. The specific arrangement of the first polarizer layer 400 can be determined according to actual demands without particularly limited in the embodiments of the present disclosure.

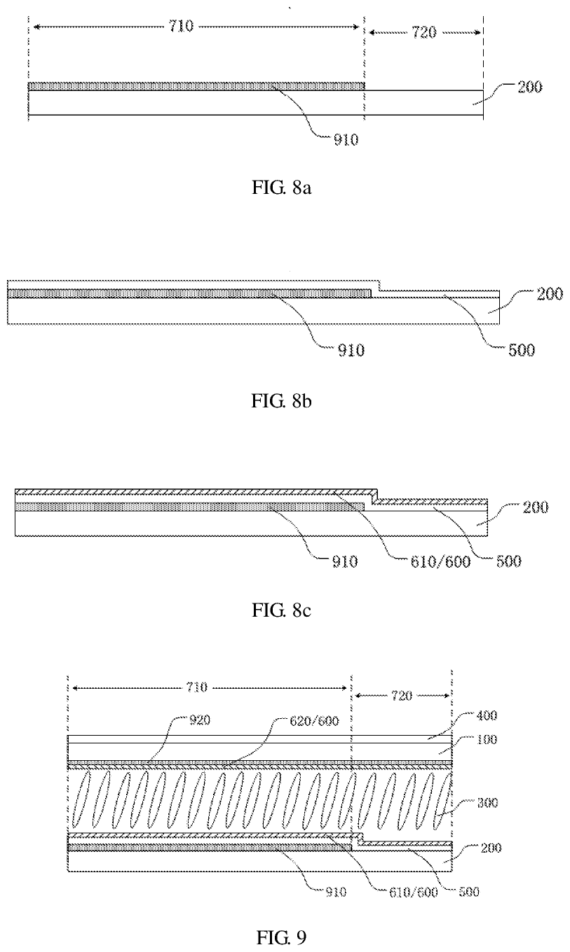

As illustrated in FIG. 8a, providing a second substrate 200. The second substrate 200 can include a plurality of sub-pixel units 710, and each of the sub-pixel units 710 is provided with a pixel electrode 910. The manufacturing process of the second substrate 200 (e.g., the manufacturing process of the thin film transistor) can be referred to that of the existing second substrate, without repeating the details herein.

As illustrated in FIG. 8b, forming a second polarizer layer 500 on the second substrate 200. The second polarizer layer 500 allows transmitted light to have a first polarization direction, and the first polarization direction is parallel to the third polarization direction. For example, the second polarizer layer 500 can be a nano grating, and can be disposed on the second substrate 200 by nanoimprint lithography.

As illustrated in FIG. 8c, forming a first alignment layer 610 on the second substrate 200. During preparing the first alignment layer 610 and preparing the second alignment layer 620 as illustrated in FIG. 7b, a rubbing direction of the first alignment layer 610 is perpendicular to a rubbing direction of the second alignment layer 620. In this way, the initial twist angle of the LC layer can be set as 90 degrees.

As illustrated in FIG. 9, assembling the first substrate 100 with the second substrate 200 to form a cell, and filling a LC layer 300 between the first substrate 100 and the second substrate 200. The first alignment layer 610 and the second alignment layer 620 allow the LC layer 300 applied with no voltage to have a same initial twist angle, for example, the initial twist angle can be 90 degrees.

The following statements should be noted:

(1) The accompanying drawings involve only the structure(s) in connection with the embodiment(s) of the present disclosure, and other structure(s) can be referred to common design(s).

(2) For the purpose of clarity only, in accompanying drawings for illustrating the embodiment(s) of the present disclosure, the thickness and size of a layer or a structure may be enlarged. However, it should understood that, in the case in which a component or element such as a layer, film, area, substrate or the like is referred to be “on” or “under” another component or element, it may be directly on or under the another component or element or a component or element is interposed therebetween.

(3) In case of no conflict, features in one embodiment or in different embodiments can be combined.

The above are merely exemplary embodiments of the present disclosure, and are not intended to limit the scope of the present disclosure. The scope of the present disclosure is defined by the appended claims.

1. A display panel, comprising:
a first substrate;
a reflective second substrate opposite to the first substrate;
a liquid crystal (LC) layer located between the first substrate and the second substrate;
a first polarizer layer located at a side of the LC layer far away from the second substrate;
a second polarizer layer located between the LC layer and the second substrate, the second polarizer layer being configured to allow transmitted light to have a first polarization direction, wherein
in the case where the LC layer is not applied with any voltage, light transmitted through the LC layer and the first polarizer layer has a second polarization direction, and the first polarization is substantially perpendicular to the second polarization direction.

2. The display panel according to claim 1, further comprising:
an alignment layer, the alignment layer being located on at least one of the first substrate and the second substrate, wherein
the alignment layer is configured to allow the LC layer to have a same, initial twist angle in the case where the LC layer is not applied with any voltage.

3. The display panel according to claim 2, wherein the first polarizer layer is configured to allow transmitted light to have a third polarization direction, and
the initial twist angle of the LC layer is set as 0 degree, the third polarization direction is perpendicular to the first polarization direction.

4. The display panel according to claim 2, wherein the first polarizer layer is configured to allow transmitted light to have a third polarization direction, and
the initial twist angle of the LC layer is set as 90 degrees, the third polarization direction is parallel to the first polarization direction.

5. The display panel according to claim 1, wherein
the second polarizer layer is configured as a nano grating.

6. The display panel according to claim 1, wherein
the first polarizer layer is between the first substrate and the second substrate; or
the first polarizer layer is at a side of the first substrate far away from the second substrate.

7. The display panel according to claim 1, wherein
the display panel comprises a plurality of pixel units, and each of the pixel units comprises at least one sub-pixel unit, and an interval region between adjacent sub-pixel units is in a normally black state.

8. The display panel according to claim 7, wherein
the second substrate comprises a plurality of gate lines and data lines, the gate lines and the data lines are intersected with each other to define the at least one sub-pixel unit, a position on the second substrate corresponding to each sub-pixel unit is provided with a pixel electrode.

9. The display panel according to claim 8, wherein
the pixel electrode is configured as a reflective electrode, and the pixel electrode is located between the second polarizer layer and the second substrate.

10. The display panel according to claim 8, wherein
a side of the first substrate facing the LC layer is provided with a common electrode, the pixel electrode and the common electrode are configured to apply a voltage onto the LC layer so as to adjust a twist degree of the LC layer corresponding to the sub-pixel unit.

11. A display device, comprising the display panel according to claim 1.

12. A manufacturing method of a display panel, comprising:
providing a first substrate, and forming a first polarizer layer on the first substrate;
providing a reflective second substrate, and forming a second polarizer layer on the second substrate, the second polarizer layer allowing transmitted light to have a first polarization direction;
assembling the first substrate with the second substrate to form a cell, and forming a liquid crystal (LC) layer between the first substrate and the second substrate, wherein
the first polarizer layer is formed at a side of the LC layer far away from the second substrate, the second polarizer layer is formed between the second substrate and the LC layer, and in the case where the LC layer is not applied with any voltage, light transmitted through the LC layer and the first polarizer layer has a second polarization direction, the first polarization is substantially perpendicular to the second polarization direction.

13. The manufacturing method according to claim 12, further comprising:
forming an alignment layer on at least one of the first substrate and the second substrate, wherein
the alignment layer allows the LC layer to have a same, initial twist angle in the case where the LC layer is not applied with any voltage.

14. The manufacturing method according to claim 13, wherein
the first polarizer layer allows transmitted light to have a third polarization direction, and the initial twist angle of the LC layer is set as 0 degree, the third polarization direction is perpendicular to the first polarization direction; or,
the first polarizer layer allows transmitted light to have a third polarization direction, and the initial twist angle of the LC layer is set as 90 degrees, the third polarization direction is parallel to the first polarization direction.

15. The manufacturing method according to claim 12, further comprising:
forming a common electrode at a side of the first substrate facing the LC layer, and forming a pixel electrode at a side of the second substrate facing the LC layer, wherein
the pixel electrode and the common electrode apply a voltage onto the LC layer so as to adjust a twist degree of the LC layer corresponding to the sub-pixel unit.

16. The display device according to claim 11, wherein the display panel further comprises:
an alignment layer, the alignment layer being located on at least one of the first substrate and the second substrate, wherein
the alignment layer is configured to allow the LC layer to have a same, initial twist angle in the case where the LC layer is not applied with any voltage.

17. The display device according to claim 16, wherein the first polarizer layer is configured to allow transmitted light to have a third polarization direction, and
the initial twist angle of the LC layer is set as 0 degree, the third polarization direction is perpendicular to the first polarization direction.

18. The display device according to claim 16, wherein the first polarizer layer is configured to allow transmitted light to have a third polarization direction, and
the initial twist angle of the LC layer is set as 90 degrees, the third polarization direction is parallel to the first polarization direction.

19. The display device according to claim 11, wherein
the first polarizer layer is between the first substrate and the second substrate; or
the first polarizer layer is at a side of the first substrate far away from the second substrate.

20. The display device according to claim 11, wherein
the display panel comprises a plurality of pixel units, and each of the pixel units comprises at least one sub-pixel unit, and an interval region between adjacent sub-pixel units is in a normally black state.
